(19) United States
(12) Patent Application Publication
(10) Pub. No.: US 2001/0047386 A1
(43) Pub. Date: Nov. 29, 2001

(54) Systems and methods for supporting on-line delivery of communication services

(76) Inventors: George C. Domenikos, Chelsea, MA (US); Steven D. Domenikos, Millis, MA (US)

Correspondence Address: ROPES & GRAY, ONE INTERNATIONAL PLACE, BOSTON, MA, 02110-2624, US

(21) Appl. No.: 09/789,478

(22) Filed: Feb. 20, 2001

Related U.S. Application Data
(60) Provisional application No. 60/183,190, filed on Feb. 17, 2000.

(51) Int. Cl. G06F 15/16

(52) U.S. Cl. 709/203

(57) ABSTRACT

Systems and methods for supporting the delivery of communication services to a consumer from a plurality of different vendors. To this end, these systems may include a flexible and scalable middleware server platform that allows for the facile integration of a vendor's communication service and that presents to the consumer a user interface that accepts an enterprise-wide password identification number (PIN) that the server may employ to grant the consumer access to a plurality of different vendors, each offering different products and services. The PIN may be representative of a phone number that the is assigned to and belongs to the consumer. Account information, including balance and subscribed services may be maintained by the server platform for that PIN account.

### REFERENCE TO RELATED APPLICATIONS

This case claims priority to U.S. Provisional Application Serial No. 60/183,190 filed Feb. 17, 2000, entitled “SYSTEMS AND METHODS FOR PROVIDING PERSONALIZED COMMUNICATION SERVICES OVER THE INTERNET”, naming Steven Domenikos as an inventor, the contents of which being hereby incorporated by reference.

### FIELD OF THE INVENTION

This invention relates to systems and methods for providing communication services over a computer network, such as the Internet, and more particularly, to systems and methods that provide and coordinate the delivery of personalized communication services including services offered from a plurality of different vendors.

### BACKGROUND OF THE INVENTION

The intelligent selection and purchase of communication services, such as long distance services, cellular/PCS services, Internet access, and messaging, is an important part of running a business. Typically a small business owner must review the services available from a host of different vendors, compare the different options, and then select different services by contacting the different service providers, and setting up separate accounts with these service providers. Each month, the business owner then receives an invoice from each of these service providers and must track each account and pay each separate invoice. Although this process can work in providing the business owner with the necessary communication services to maintain a business, the process is time-consuming and cumbersome. Moreover, the consumer is limited to the options available from the vendors, often finding that the available options are not exactly suited to their needs.

Further, the delivery of communication services and products can, itself, be a cumbersome process ill suited to a telecommunication company that may be more adept at designing, building and supporting communication functions. In fact it is often difficult for small communication service providers, such as Internet service providers, messaging service providers, and long distance service providers, to develop distribution channels that are successful and robust. In fact, communication service providers are often confronted with the chore of having to build out sales, delivery and support systems for their products. Unfortunately, the systems and methods available today for building out such sales and support systems are no different than the systems which have existed for years, and require these service providers to invest in sales staffs, advertising, support centers and other such costly infrastructure.

Accordingly, there is a need in the art for systems and methods that make it more facile for a consumer to purchase and modify communication services.

Additionally, there is a need for a system that simplifies the purchase of telecommunication services and that can present a consumer with choices of services from a number of different vendors, for a number of different services.

Similarly, there is a need in the art for systems and methods that make it more facile for communication service providers to sell, distribute and service communication products to the marketplace.

### SUMMARY OF THE INVENTION

The systems and methods described herein include systems for delivering to consumers products and services, including communication services, from a plurality of different vendors. To this end, these systems may include a flexible and scalable middleware server platform that facilitates the delivery of services to a consumer and that makes it more easy for a consumer to purchase such products. For example, the middleware platforms described herein may present to a consumer a user interface that accepts an enterprise-wide password identification number (PIN) that the server may employ to grant the consumer access to a plurality of different vendors, each offering different products and services. The PIN may be representative of a phone number that is assigned to and belongs to the consumer. Account information, including balance and subscribed services can be maintained by the server platform for that PIN account.

At the consumer's option, the consumer can access the server platform to purchase telecommunication services that may be associated with the consumer's PIN. For example, the consumer may buy messaging services for the PIN, so that callers calling the PIN can leave messages and these messages can be forwarded to a voice mail account, or a “follow me” number that the consumer has selected for the messaging service. Other services, from other vendors, may also be purchased by the consumer for the pin. Thus for example, the consumer can buy long distance services and other services that all can attach to the PIN.

To facilitate these transactions, the middleware server may then employ the consumer account information for negotiating transactions with the different vendors. To this end, the middleware server platform acts as a stored value platform and may include processes that can communicate, optionally in real time, with the servers of the different vendors, for negotiating according to the protocol and data format required by that server. Through this middleware server the consumer may purchase and receive online delivery of services from that vendor. The middleware platform can negotiate the purchase of services in real time to allow the user to have one account for paying for the services of multiple vendors. Optionally, the middleware sever may also modify or supplement the telecommunication services offered by different vendors. For example, by keeping track of accounts and billing, the middleware server may add a prepay function to the long distance services of a consumer's pin account, even if the original vendor did not provide prepay options.

More particularly, the systems described herein include a middleware server platform that provides an intuitive web-based user interface that enables online consumers to purchase products online and in real-time. Optionally, the server provides for product customization based on the consumer's needs. This can include selecting the amount of the service to buy, and limiting the users to the service. The server can further include a transaction processing back-end payment system that is capable of achieving real-time funds disbursement between consumers and corporate partners. In this regard, the middleware server acts as the delivery agent between end-users and telecom service providers. Optionally, the server includes a secure real-time product delivery engine that is capable of supporting the merchandising and the market availability of telecommunication product and services. Thus, the system may provide an industry standard which telecommunication merchants can adhere to for purposes of making their services available online.

Further optionally, the system can provide a comprehensive manager component that controls the e-commerce and back-end activities, while providing for such tasks as product management, customer support, reporting in data mining, visitor profiling and instant product merchandising. Additionally, a business API framework component may be included that allows different telecommunication technologies to integrate products and services with the platform. Consequently, this platform may be employed to process and administrate individual e-commerce operations.

Additionally, in one embodiment the systems and methods described herein will be understood to include systems for delivering communication services through an online distribution channel. Such systems may comprise a server platform having a customer interface for communicating with a customer and having a telecom server for communicating with a puerility of providers of communication services, the telecom server being capable of generating data streams of an extensible mark-up language for delivery to a puerility of communication service providers. Such systems may also include a computer network for coupling these server platforms and the providers of communication services, and a process processing the data stream and for responding to the extensible data stream to generate one or more system calls, wherein each communication service provider includes an interface for receiving the system calls and for providing a telecommunication function in response thereto.

Such systems may include telecom servers that comprise secure servers such as the Apache Secure Server that may implement the secure socket layer (SSL) protocol. The network between the telecom server and the communication service providers may be any suitable network, however, typically it will be the Internet or some other type of wide area network. The processes for processing the data stream may include any suitable type of computer process and will include Java applications including multi-threaded Java applications.

Each communication service provider may include an interface that comprises an application program interface to the process that processes the data stream. The data stream may comprise any suitable extensible mark-up language including HTML, XML, SGML, VRML, VXML, WML or any proprietary mark-up language developed for any particular application.

In further embodiments, the server platform may include a transaction processor for allowing a customer to purchase communication services associated with the communication service providers. The transaction processor may provide a user interface that is capable of allowing a customer to access services from different service providers. The transaction processor may also include a profiling process for generating a profile for a customer wherein the generated profile provides information that may be employed for selecting communication services to offer to the customer. Similarly, the transaction processor may include a purchasing profiling process for identifying characteristics of purchased products and for recommending modifications to such products for creating new customer offerings. Additionally, the transaction processor may also include a purchasing process for allowing a user to purchase communication services during a purchasing session.

In another aspect, it will be understood that the systems and methods described herein include methods for allowing a communication service provider to deliver communication services through an online distributor. Such methods may include exposing services provided by the communication service provider by having an interface to a process with a set of abstract services representative of common features of a communication service, and providing a process for communicating with the interface and for performing the set of abstract services, and for streaming data between the process and a telecom server in response to a customer having purchased or otherwise secured communication services.

### BRIEF DESCRIPTION OF THE DRAWINGS

The foregoing and other objects and advantages of the invention will be appreciated more fully from the following further description thereof, with reference to the accompanying drawings wherein;

FIG. 1 depicts a functional block diagram of one system according to the invention;

FIG. 2 depicts in more detail a middleware server suitable for use with the system depicted in FIG. 1;

FIG. 3 depicts in more detail a middleware server for supporting the delivery of communication services,

FIGS. 4 and 5 present pictorial representations of graphical user interfaces for allowing a consumer to subscribe to telecommunication services, and manage those telecommunication services through the middleware server depicted in FIG. 2.

### DESCRIPTION OF CERTAIN ILLUSTRATED EMBODIMENTS

To provide an overall understanding of the invention, certain illustrative embodiments will now be described, including a server system that allows a consumer to access and subscribe to telecommunication services offered from a plurality of different vendors. However, it will be understood by one of ordinary skill in the art that the systems and methods described herein can be adapted and modified for other suitable applications, including for offering services and products from other types of vendors, such as financial service providers or utility providers, purchasing, leasing or renting videos, MP3s, pay per view or other services that can be delivered on-line and that such other applications, additions and modifications will not depart from the scope hereof.

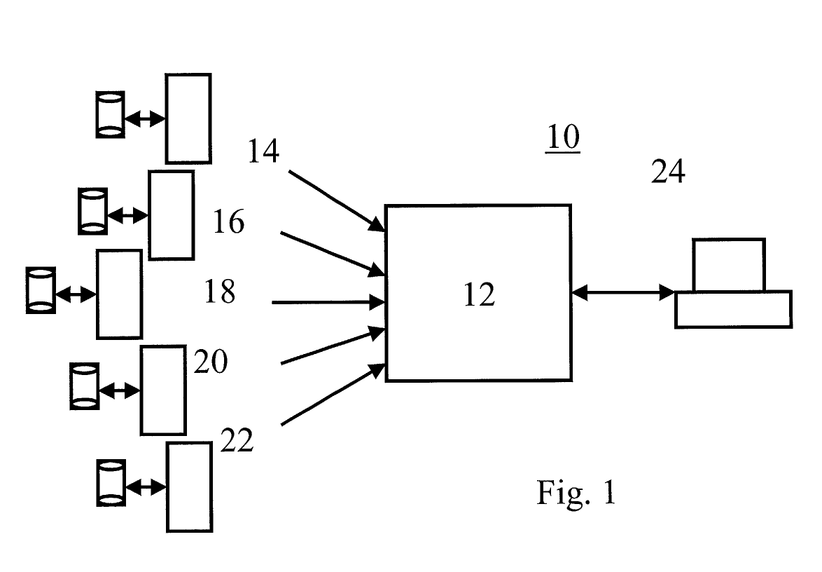

FIG. 1 provides a high-level view of one embodiment of system 10 according to the invention that allows a consumer to subscribe to telecommunication services offered from a plurality of different vendors. As can be seen from FIG. 1, the system 10 acts as a middleware platform that comprises an E-commerce platform 12 that converges to a single point, multiple communication services offered from multiple vendors. As depicted in FIG. 1, the middleware server platform 12 may converge long-distance telecommunication services 14, wireless services 16, messaging services 18, paging services 20 and other services 22 to a single point, and may provide one consumer 24 with access to some or all of the services. To this end, the system 10 may provide a website, or other type of access site, that acts as a central location to which a consumer 24 may go and select at that location, multiple different types of communication services offered from different vendors. The consumer 24 may be an individual, a group, a business or some other entity. By providing a consumer 24 with integrated access to different types of services and different service providers, it is understood that the consumer 24 will receive greater choices and more competitive pricing for similar services. Moreover, the centralized site may also, optionally provide a central location for offering customer support for each of the separate vendors and services. Other advantages of having a central site for subscribing to and comparing different telecommunication services will be apparent to those of ordinary skill in the art.

It will also be understood from reviewing FIG. 1, that the system 10 provides a sales and distribution channel for the communication service providers associated with the services 14-22. In practice, each of the offered services may be provided by a separate communication service provider, however, in certain practices a single service provider may offer multiple types of services, as well as multiple offerings and types on a particular service. The depicted communication service providers 14-22 can be any such service providers, such as the Wildfire Corporation of Massachusetts, Connexus Communications, America Online of Virginia, Boston Communication Group, Bell Atlantic Mobile or any other communication service provider. Additionally, and optionally, other types of service providers may also integrate their services into the platform 12. Such services may include financial services, real estate services, leasing and credit services, and other such services and products. The service providers 14-22 are depicted as server systems in FIG. 1, however it will be apparent to those of ordinary skill in the art, that the service provider may comprise a complete facility having a telco equipment suitable for the telco applications at hand. Moreover, such providers may have distributed equipment. However, the integration of the communication service providers system with the platform 12 depicted in FIG. 1 may be by techniques known to those of skill in the art, and employing different techniques for performing such integration shall not depart from the scope of the invention.

In operation, when accessing the site provided by the server 12, the consumer 24 may create an account that may include all the relevant information for allowing that user to subscribe to various telecommunication services offered by the server 12. For example, the consumer may create an account that will store information about the user's name, address, credit card information and other information of the type commonly employed for purchasing telecommunication services. Once the account information is entered at the site 12, the site 12 may present the user with a menu of services from which the consumer may choose. In one practice, the consumer is allowed to select from a plurality of different menus, each menu related to a particular type of telecommunication service such as long-distance service, or wireless services. Continuing with this example, the server 12 may respond to a consumer's selection of one menu, such as the long-distance menu, by providing to the consumer a web page that describes the different long distance services available for purchase.

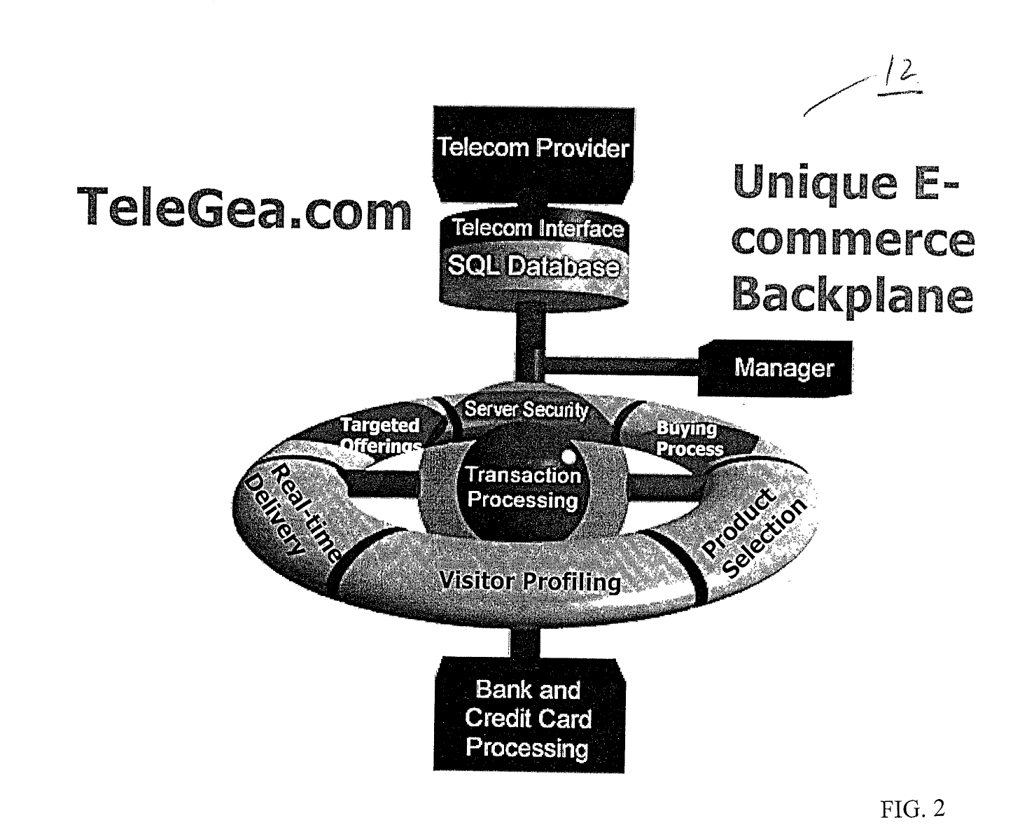

FIG. 2 depicts at a functional block diagram 1 middleware server system 12 suitable for use with the system depicted in FIG. 1. Specifically, FIG. 2 depicts a middleware server system 12 that may perform the transaction processing for allowing a consumer to purchase telecommunication services for a plurality of different telecom providers. To this end, the depicted middleware server 12 includes processes for allowing a consumer to perform product selection and product buying, through the buying process. The transaction processor of the server 12 may include a server mechanism that operates to insure that data, such as financial data, is exchanged in a secure manner between a consumer and the server 12.

The transaction processing mechanism of the server 12 sits between the credit card processing element and the telecom interface to the telecom provider. Accordingly, the transaction processor may respond to information provided by a consumer and representative of credit card information for verifying the consumer's financial credentials, and charging to the provided credit card, the fee for purchasing a service provided by one or more of the telecom providers. The transaction processing mechanism may be a software process that understands the protocol for negotiating a financial transaction with the telecom providers coupled to the middleware server 12. This can include having internationalized transaction processing that takes into consideration local currencies and tariffs. The transaction processor may operate in real time to use the credit information provided by the consumer to receive online verification of the purchase of a telecommunications service from one of the telecom providers. Moreover, the transaction processor may collect from the telecom provider the necessary information for allowing the consumer to begin using the purchased telecommunication service.

For example, if the consumer purchases messaging services by providing a credit card to the middleware server 12, and directing the middleware server 12 to purchase 200 minutes of messaging service provided by a telecommunications provider that offers unified messaging services, the transaction processor may collect from the telecommunication provider the phone number, or PIN, that may be delivered to the consumer and that the consumer may employ for accessing their unified messaging service. A pin may be an abstraction for a plurality of access codes and data for different services and vendors. The systems described herein may employ a PIN mapping that maps an abstract PIN to one or more vendor PINs. Information about the purchased telecommunication service may be stored within the SQL database depicted in FIG. 2. This information may include a service purchased by the consumer, the date of the purchase, the cost of the service, and the duration, such as one or two months or 2 to 300 minutes of the purchased service, and any other characteristics that are suitable for storing within the depicted database.

FIG. 2 further depicts that the middleware server 12 includes a manager process that may act to manage the different telecom services offered through the middleware server 12. For example, the manager service may enable the creation, and modification of vendors, vendor inventory (real time or static) vendor ratings, and vendor triggers of product inventory.

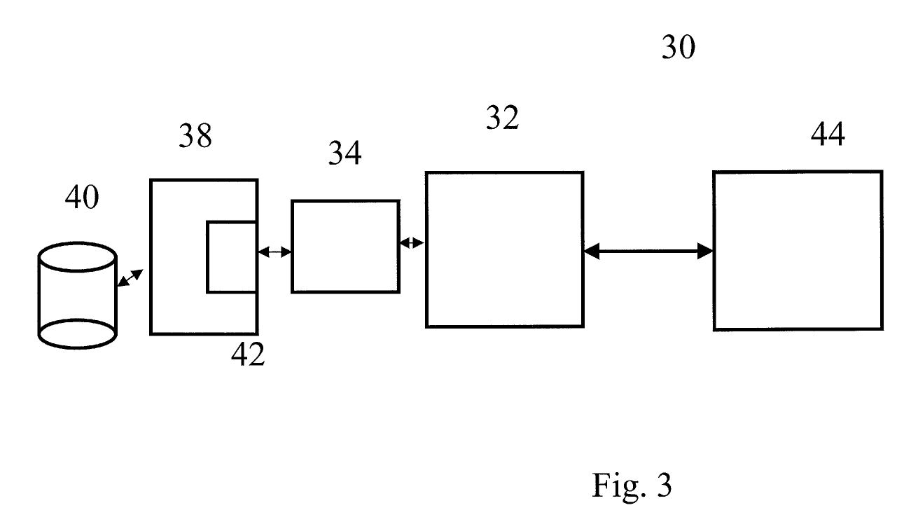

Turning to FIG. 3, the interface between the telecom service provider and the middleware platform is shown in more detail. Specifically, FIG. 3 depicts a system 30 wherein a telecom service provider 38, including a database 40, has an interface 42 that allows the telecom service provider 38 to communicate with a process 34. The process 34 provides a set of abstract functions that may be accessed by the telecom service provider 38 through the interface 42. For example, the interface 42 may be a program that accesss an application program intercae exported or otherwise offered by the process 34. The process 34 may be a conventional computer process and in one embodiment comprises an application written in Java to facilitate the deployment across different platforms.

The process 34 communicates with the server 32, which may be a web server. The server 32 can communicate with the middleware platform 44, that may be similar to the middleware platform described above.

In one particular embodiment, the system 30 streams data in an extensible mark-up language format between the middleware platform 44 and the server 32. The extensible mark-up language may be XML, WML, SGML, SXML, a proprietary mark-up language or any of the other conventional languages. The Process 34 parses the data stream and delivers information to the telco service provider 38 through the interface 42. The interface 42 brokers between the abstracted commands, requests and responses and the telco specific commands, requests and responses for that telco 38. Thus FIG. 3 depicts the interface's high-level architecture. It shows the main components that make up the interface. Assuming that the vendor already has a proprietary telecom supply system and considering that the interface calls for the use of an HTTP Web server and allows for the use of freely available XML parsers, thus providing real time interfaces. For the above described embodiment, there are no operating systems, database system, nor hardware platform specific requirements. The only system requirement is a standards requirement that an HTTP 1.1 compliant Web server be used to implement the server (vendor's) interface.

The telco server may support the secure socket layer so that the request and response data sent between the telco server (the “vendor”) and the middleware platform 44 is encrypted. In this practice, the vendor may obtain certificates and keys to utilize the SSL from that server.

Typically, the vendor's server 32 will not grant access to its system, any machine that is not one of a pre-determined set of clients. Most commercial Web servers allow access to be restricted to a set of IP addresses. The middleware platform should be supplied an ID and password by the vendor. All resources and requests to the vendor's Web server should be authenticated against that ID.

In one operation the pointer to the server 32, typically the URL, will be appended with a QUERY_STRING representing the desired transaction. The middleware platform 44 will provide the vendor with a complete set of machine IP addresses that could possibly submit a request to the vendor's Web resources. Each transaction consists of XML input, the QUERY_STRING, and XML output. There are also a few HTTP specific rules that the vendor can follow in its implementation of the transactions. This section will provide a general description of the inputs, QUERY_STRING, outputs, and HTTP rules. Because the contents of the request may be fairly large, all requests made to the vendor's server will use the POST method. Optionally, the method may support multi-part data to facilitate file uploading of the XML input. Because the document type of the response is XML data, the vendor can set the HTTP response “content-type” header to “text/xml”. XML data streams are used for both input and output. XML was selected because it allows us to define the system with what data (features, products, rates, etc.) is available now, yet remain flexible for future additions. For example, out initial implementation will allow for one request to be made per transaction. Multiple requests may be processed per transaction. Therefore, there may be a defined the format of the XML request to be:

<requestlist>

<request>

<id>1001</id>

. . . .

</request>
<request>
<id>1002</id>

. . . .

</request>

. . . .

<request>

<id>1111</id>
. . . .

</request>

</requestlist>

This definition of a request allows for limiting the number of requests per transaction to one, but allows for extending that number later. XML responses may be similarly marked up so that each request receives an independent response.

The URL QUERY_STRING will contain name/value pairs describing the type of transaction to be submitted. To keep this interface simple, if there is only one request in the transaction, the fields of the request itself may be represented as name/value pairs so that an XML input data stream will not be necessary.

The first name/value pair is transaction. It can have the following values:

transaction=GetPlans

transaction=GetPins

transaction=GetCDRs

transaction=PinCommand

The next name/value pair is xmlstream. It is a URL_encoded stream of XML data representing the specifics of the transaction. Optionally, the system may upload this stream as a file. The following represents a QUERY_STRING containing xmlstream:

https://server1.vendor.com/interface.app?transaction=GetPlans&xmlstream=XXXX

Where XXXX is the URL_encoded form of the XML stream:

<requestlist>

<request>

<id>1001</id>
<command>GetPlans</command>
<begindate>10011999</begindate>
<enddate>10012000</enddate>

</request>

</requestlist>

As stated above, if a transaction has just one request, then the xmlstream name/value pair may be replaced by a name/value pair for each of the fields of that request. The following represents a QUERY_STRING that contains the request fields directly rather than in an xmlstream name/value pair:

https://server1.vendor.com/interface.app?transaction=GetPlans&command=GetPlans&begindate=10011999&enddate=10012000

One example of a transaction is set forth below.

This transaction should retrieve an XML document containing all of the telecom products and rate plans offered by the vendor.

The inputs for this transaction are: id, command, begindate, and enddate. The id field represents the system/platform request id. The command field contains the requested command. Currently, there is only one command for this transaction, “GetPlans”, the same as the transaction itself. The other two fields are the date range for the desired command. Their format is YYYYMMDD.

An example of a “GetPlans” transaction follows:

<requestlist>

<request>

<id>1001</id>
<command>GetPlans</command>
<begindate>19991001</begindate>
<enddate>20001001</enddate>

</request>

</requestlist>

Note: The fields of this XML request must be more formalized. It should be generalized to facilitate the input needs of all vendors. Once it is more formalized, we will write up a formal DTD so that we can make use of freely available XML validators.

As stated above, the QUERY_STRING contains the name/value pair transaction which should be set to “GetPlans”. Then either the URL-encoded form of the XML stream above may be applied to the xmlstream name/value pair or (for single requests transactions only) each of the fields of the request may be represented as name/value pairs.

The output of the transaction should be an XML document containing descriptions of all of the products and plans offered by the vendor. The output data will include id, command, returncode, begindate, enddate, plan, shortdescriptoin, detaileddescription, costperminute, connectionfee, planid, productid, region, etc. . . .

An example of the expected XML output follows:

<responselist>

<response>

<id>1001</id>
<command>GetPlans</command>
<returncode>0</returncode>
<begindate>19991001</begindate>
<enddate>20001001</enddate>
<plan>
<planid>usal</planid>
<shortdescription>

Flat rate cost to cost.

</shortdescription>
<detaileddescription>

This rate is great because . . .

<<detaileddescription>
<costperminute>0.10</costperminute>
<connectionfee>1.00</connectionfee>
<vendorprocuctid>6634</vendorprocuctid>
<productid>longdistance</productid>
<region>usa</region>
. . .

</plan>
. . .
<plan>

<planid>EuropeCell6</planid>
<short description>

Cellular all over Europe.

</shortdescription>
<detaileddescription>

This rate is great because . . .

| | .</detaileddescription> |
|---|---|
| | <costperminute>0.20</costperminute> |
| | <connectionfee>2.00</connectionfee> |
| | <vendorprocuctid>6635</vendorprocuctid> |
| | .<productid>cellular</productid> |
| | <region>europe</region> |
| . | -. . |

</plan>

</response>

</responselist>

The above example illustrates that the system of FIG. 3 can faciltate the integration of a tele service provider platform in the middleware/e-commerce platform of FIGS. 1 and 2, thus providing a system that supports delivery of communication services.

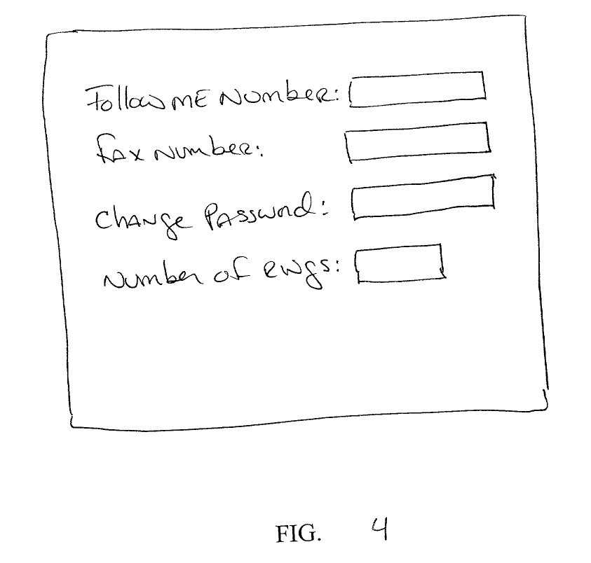

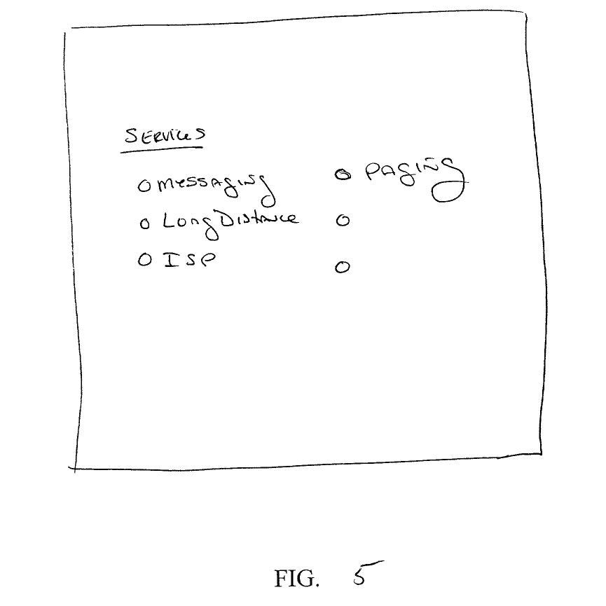

Turning now to FIGS. 4 and 5 two exemplary graphical user interfaces are presented. Specifically, FIG. 4 depicts an interface that may be presented to a consumer coming to the website provided by the middleware server 12. Through this interface, the consumer may view the different services offered by the middleware server 12. The consumer may select from among the different services to choose the service the consumer wishes to employ. Once the service is selected, the transaction processor depicted in FIG. 2 can operate to negotiate with the telecom provider to purchase the selected service for the consumer, and to receive from the telecom provider that information which is required for the user to have to employ the purchased services.

Turning now to FIG. 5, it can be seen that in a further embodiment, the middleware server 12 may provide an interface that allows the consumer to control how the service is actually provided. Through this interface, the consumer may be presented with a graphical user interface that allows the consumer to set up controls for directing the telecom provider to operate in a certain manner. For example, the server 12 may provide a set of controls that allows the user to set up instructions for changing follow-me numbers for a messaging service, thereby allowing a consumer to coordinate follow-me numbers with the consumers schedule. To this end, the server 12 can respond to instructions provided by the consumer, and can translate these instructions into commands that may be delivered to the telecom provider to change the instructions at the site of the telecom provider.

It will be understood, that although the depicted middleware server 12 is graphically depicted as a functional block diagram, it will be apparent to one of ordinary skill in the art that the depicted elements can be realized as computer programs or portions of computer programs that are capable of running on a data processor platform to thereby configure the data processor as a system according to the invention. Moreover, although FIG. 2 depicts the system 12 as an integrated unit, it will be apparent to those of ordinary skill in the art that this is only one embodiment, and that the invention can be embodied as a plurality of separate computer processes. The computer processes can be implemented as a C language computer programs, or computer programs written in any high level language including C++, Fortran, Java or Basic. The development of such programs follow from general techniques for high level programming known in the art, including those set forth in, for example, Stephen G. Kochan, Programming in C, Hayden Publishing (1983).

Additionally, it will be understood that the server 12 may comprise one or more object oriented frameworks. As is known to those of skill in the art, object oriented frameworks are generally understood as a set of classes that embody an abstract design for solutions to a family of related problems. See The C++ Programming Language, 2nd Ed., Stroustrup Addision-Wesley. Accordingly, a framework provides a prefabricated structure, or template, of a working program. For example, for a traditional application program, a framework may provide support and “default” behavior for drawing windows, scroll bars and menus. Optionally, a framework may provide sufficient functionality and wired-in interconnections between object classes to provide an infrastructure for a developer developing services for the server 12. The interconnections are generally understood to provide the architectural model and design for developers, allowing developers to focus on the problem domain and allowing increased levels of hardware independence, as frameworks may provide to developers abstractions of common communication devices reducing the need to include within a service application hardware dependent code.

The design and development of object oriented frameworks, such as the framework that may comprise the server 12 described herein follows from principles known in the art of computer science, such as principles set forth in Booch, Grady, “Designing an Application Framework”, Dr. Dobb's Journal 19, No. 2, (February, 1994); Booch, Grady, “Object Oriented Analysis and Design With Applications”, Redwood City, Calif. Benjamin/Cummings (1994); and Taligent, “Building Object Oriented Frameworks”, Taligent, Inc., (1994).

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

1. A system for delivering communication services through an on-line distribution channel, comprising
a server platform having a customer interface for communicating with a customer and having a telcom server for communicating with a plurality of providers of communication services, the telcom server being capable of generating data streams of an extensible mark-up language for delivery to a plurality of communication service providers,
a computer network for coupling the server platform and the providers of communication services, and
a process for parsing the data stream and for responding to the parsed data stream to generate one or more system calls,
wherein each communication service provider includes an interface for receiving the system calls and for providing a telecommunication function in response thereto.

2. A system according to claim 1, wherein telecom server comprises a secure server.

3. A system according to claim 2, wherein the secure server provides functionality for secure socket layer data transfers.

4. A system according to claim 1, wherein the computer network includes the Internet.

5. A system according to claim 1, wherein the process includes a Java application.

6. A system according to claim 1, wherein the process comprises a multi-threaded process.

7. A system according to claim 1, wherein each communication service provider includes an interface that comprises an application program interface to the process for parsing the data stream.

8. A system according to claim 1, wherein the extensible mark-up language includes a language selected from the group consisting of HTML, XML, SGML, SXML, WML and VRML.

9. A system according to claim 1, wherein the server platform includes a transaction processor for allowing a customer to purchase communication services associated with the communication service providers.

10. A system according to claim 9, wherein the transaction processor provides a user interface capable of allowing a customer to access to services from different service providers.

11. A system according to claim 9, wherein the transaction processor includes a profiling process for generating a profile for a customer and wherein the generated profile provides information for selecting communication services to offer to the customer.

12. A system according to claim 9, wherein the transaction processor includes a purchasing process for allowing a user to purchase communication services during a purchasing session.

13. A system according to claim 9, wherein the transaction processor includes a product profiling process for identifying characteristics of purchased products and for recommending modifications to the products for creating new customer offerings.

14. A process for allowing a communication service provider to deliver communication services through an on-line distributor, comprising
exposing services provided by the communication service provider by having an interface to a process with a set of abstract services representative of common features of a communication service,
providing a process for communicating with the interface and for performing the set of abstract services, and
streaming data between the process and a telcom server responsive to requests from a customer for securing communication services.

15. A process according to claim 14, exposing services includes interfacing with an application program interface.

16. A process according to claim 14, including providing a secure path between the process and the telcom server.

17. A process according to claim 14, including providing the telcom server with a transaction processor for processing requests from a customer to interact with a communication service provider.

18. A process according to claim 14, including exposing services of a plurality of communication service providers.

19. A process according to claim 18, including providing the telcom server with a uniform user interface for allowing a customer to access the plurality of communcation service providers through one interface.

20. A process according to claim 17, including providing a credit processing process for allowing a customer to purchase services.
